(19) United States
(12) Patent Application Publication
(10) Pub. No.: US 2005/0149895 A1
(43) Pub. Date: Jul. 7, 2005

(54) Delay library generation method and delay library generation device

(75) Inventor: Tetsurou Toubou, Hyogo (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/016,805

(22) Filed: Dec. 21, 2004

(30) Foreign Application Priority Data
Dec. 26, 2003 (JP) 2003-435316

(51) Int. Cl. G06F 17/50

(52) U.S. Cl. 716/6; 716/5

(57) ABSTRACT

A delay library of high accuracy is efficiently generated within a short time period. To this end, a set-up time is calculated by static analysis with no consideration of a delay caused by a wire; the initial value of the search range for the next binary search cycle is set such that the set-up time is the median value of the search range (for example, the range of 0.5 ns is set); and correct set-up time α is obtained using binary search based on the initial value of the search range.

### CROSS-REFERENCE TO RELATED APPLICATION

This Nonprovisional application claims priority under 35 U.S.C. §119 (a) on Patent Application No.2003-435316 filed in Japan on Dec. 26, 2003, the entire contents of which are hereby incorporated by reference.

### BACKGROUND OF THE INVENTION

1. Field of the Invention

The present invention relates to a method and device for generating a delay library including a timing constraint value and a delay value, which is used for verifying the operation timing of a semiconductor integrated circuit.

2. Description of the Prior Art

The operation timing of a semiconductor integrated circuit is verified using a delay library which includes information about circuit characteristics of each of logic circuits (logic cells) which constitute the semiconductor integrated circuit, such as a timing constraint value, a delay value, and the like. The delay library is generated by extracting the characteristics of each cell with a device called “characterize tool”. Specifically, the operation of each cell is simulated by a simulator based on a netlist which represents the connection of transistors in each cell, a test vector which represents the transition of an input signal, etc. Then, the characteristics, such as a delay value, and the like, are extracted from the result of the simulation to generate a delay library (for example, “synspec reference manual”, Excellent Design Inc., 1997 April (author unknown)).

For example, the timing constraint value, e.g., the set-up time of a flip flop circuit, which cannot be obtained by a cycle of simulation, is obtained by repeating the setting of a prediction value of the timing constraint value and simulation and converging the timing constraint value while changing the prediction value based on the simulation result. More specifically, a binary search method is used to determine whether the prediction value is larger than the timing constraint value sought to be obtained. Then, any half of the search range for the timing constraint value is determined to be a new search range, and the prediction value is set again for the new search range. The simulation and determination are repeated, whereby the timing constraint value is obtained relatively efficiently (for example, Japanese Unexamined Patent Publication No. 7-43407).

Herein, in the simulation including the above binary search process, a delay time caused by signal wires is considered. Especially in recent years, the delay time of a transistor included in a cell has decreased as a device has become finer. On the other hand, the capacitance between wires and the wire resistance have increased because the distance between wires decreases and the wire width decreases. As a result, the delay time caused by wires has been increasing. Thus, among the delay times caused during the operation of the entire cell, it is important to estimate the delay time caused by wires with high accuracy. In view of such, for example, in the case where there is a nonuniform transmission line whose two-dimensional cross-sectional shape (i.e., characteristic impedance) changes according to the position on the transmission line, the transmission line is divided into a plurality of segments, and each segment is modeled as a uniform transmission line. The modeled transmission line segments are cascaded and approximately analyzed (for example, Design Wave Magazine, “Introduction to analog circuit simulation for high-speed digital circuit design, part 5, Parameter extraction method for wire modeling (1)” by Hideki ASAI and Takayuki WATANABE, CQ Publishing Co., Ltd., 2003 April, pp. 141-146).

The above-described timing constraint value is not a fixed value for each cell but a value which varies according to various operation conditions. For example, in the case of a flip flop circuit, the set-up time changes according to the gradients of the edges of waveforms of a data signal and a clock signal (variation rate of voltage). That is, the timing constraint value can be expressed as a function of the operation conditions. The timing constraint values (candidate values), which correspond to a plurality of values of the operation condition (in the case of a plurality of operation conditions, combinations of a plurality of operation condition values), are stored in a delay library. When verifying the operation timing of the semiconductor integrated circuit, an optimum timing constraint value is obtained by interpolation. The accuracy of the timing constraint value obtained by interpolation increases as the number of timing constraint values stored in the delay library increases. When generating a delay library, the above-described simulation and binary search are performed for each operation condition value or for each combination of the operation condition values.

However, the above conventional method requires a long time for obtaining the timing constraint value.

In the case where the timing constraint value is obtained using a binary search method, it is in general difficult to predict a range including the timing constraint value. Thus, it is necessary to provide a sufficiently wide range as an initial value of the search range. As a result, a long time is required before the predicted value converges. Specifically, assuming that the initial value of the search range is 10 ns and the accuracy range of the timing constraint value sought to be obtained is 0.01 ns, 10 cycles of simulation are required because the search range is halved for every cycle of simulation. The number of simulation cycles can be decreased by decreasing the initial value of the search range (i.e., narrowing the initial search range). However, if the timing constraint value sought to be obtained is not included in that search range, it is necessary to reset the search range and perform the binary search again. As a result, a considerable length of time is required. Thus, it is difficult to predict the timing constraint value, for example, with the accuracy range of about 0.5 ns for setting the initial value of the search range.

In the case where in the simulation the transmission line is divided into a plurality of segments and each segment is modeled as a uniform transmission line for the purpose of correctly estimating the wire delay caused by a nonuniform transmission line, the accuracy of the obtained timing constraint value increases as the number of segments increases. However, the amount of calculations increases, and accordingly, the time required for one simulation cycle increases. As a result, the time required for obtaining the timing constraint value increases.

The number of simulation cycles increases as the timing constraint value is obtained with higher resolution according to the operation conditions, such as the gradient of an edge of the waveform of an input signal, etc. Thus, the above problems become more noticeable.

### SUMMARY OF THE INVENTION

In view of the above, an objective of the present invention is to efficiently generate a delay library of high accuracy within a short time period.

In order to achieve the above objective, according to the present invention, in the process of obtaining a timing constraint value of a logic circuit using a simulation of circuit operation and a binary search method, the timing constraint value is first obtained with an accuracy lower than a target accuracy, such that the initial value of the search range of the binary search method is set small (i.e., the initial search range of the binary search method is set narrow). Accordingly, the number of simulation cycles is decreased. As a result, a delay library of high accuracy is efficiently generated within a short time period.

Specifically, for example, a timing constraint value calculated based on a delay value of an element which is included in the logic circuit, i.e., a timing constraint value calculated by static analysis, is used as the initial value of the timing constraint value in the binary search process. Since such a timing constraint value has a certain degree of accuracy, the initial value of the search range can readily be set small (i.e., the initial search range can readily be set narrow).

In the case where the timing constraint values are obtained for a plurality of logic circuits of the same type or a plurality of logic circuits which include a common circuit element, the timing constraint value obtained for any one of the logic circuits is used as the initial value of the timing constraint value in the binary search process for obtaining the timing constraint values of the other logic circuits. Also with this structure, the initial value of the search range can readily be set small (i.e., the initial search range can readily be set narrow).

A timing constraint value having a certain degree of accuracy is obtained for a simplified circuit model, and the obtained timing constraint value is used as the initial value in the process of obtaining a timing constraint value for a detailed circuit model. Also with this structure, the initial value of the search range can readily be set small (i.e., the initial search range can readily be set narrow).

In the case of obtaining a plurality of timing constraint values according to the variation rate of an input signal, for example, a timing constraint value corresponding to a predetermined variation rate is first obtained, and a value calculated by interpolation or extrapolation using the obtained timing constraint value is used as the initial value in the process of obtaining a timing constraint value corresponding to a different variation rate. Also with this structure, the initial value of the search range can readily be set small (i.e., the initial search range can readily be set narrow).

It is possible that, for example, the above simulation is performed with different accuracies for signal transmission paths corresponding to (associated with) the timing constraint values or delay times to be obtained, whereby the time required for generating a delay library is further reduced.

### BRIEF DESCRIPTION OF THE DRAWINGS

FIG. 1 is a block diagram showing a structure of a delay library generation device of embodiment 1.

FIG. 2 is a circuit diagram showing a structure of a D-flip flop circuit.

FIG. 3 is a circuit diagram showing a detailed structure of a part of the D-flip flop circuit.

FIG. 4 is a circuit diagram showing a detailed structure of another part of the D-flip flop circuit.

FIG. 5 schematically illustrates the set-up time of the D-flip flop circuit.

FIG. 6 is a timing chart showing the set-up time of the D-flip flop circuit.

FIG. 7 schematically illustrates the hold time of the D-flip flop circuit.

FIG. 8 is a timing chart showing the hold time of the D-flip flop circuit.

FIG. 9 is a flowchart illustrating an operation of the delay library generation device of embodiment 1.

FIG. 10 is a flowchart illustrating details of the operation of the delay library generation device of embodiment 1.

FIG. 11 is a flowchart illustrating an operation of a delay library generation device of embodiment 2.

FIG. 12 is a flowchart illustrating an operation of a delay library generation device of embodiment 3.

FIG. 13 shows an example of modeling a nonuniform transmission line.

FIG. 14 is a graph schematically illustrating the relationship between the set-up time and the gradients of edges of the waveforms of a data signal and a clock signal.

FIG. 15 is a flowchart illustrating an operation of a delay library generation device of embodiment 4.

FIG. 16 is a graph illustrating a first plotted set-up time according to embodiment 4.

FIG. 17 is a circuit diagram showing a structure of a flip flop circuit for scan test.

FIG. 18 is a circuit diagram showing a detailed structure of a part of the flip flop circuit for scan test.

FIG. 19 is a circuit diagram showing a detailed structure of another part of the flip flop circuit for scan test.

FIG. 20 is a block diagram showing a structure of a delay library generation device of embodiment 5.

FIG. 21 is a flowchart illustrating an operation of a delay library generation device of embodiment 5.

### DESCRIPTION OF THE PREFERRED EMBODIMENTS

Hereinafter, embodiments of the present invention will be described in detail with reference to the drawings. Specifically, examples of a delay library generation device for obtaining the timing constraint value, such as a set-up time, a hold time, or the like, in a flip flop circuit, for example, will be described.

### Embodiment 1

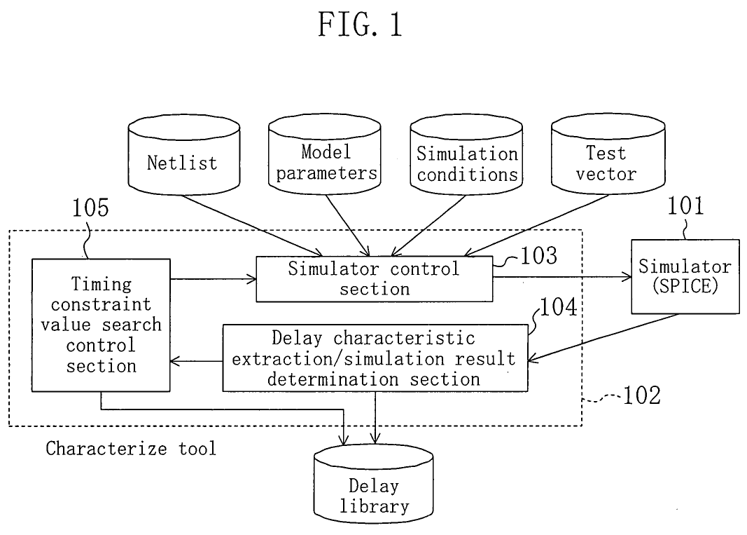

Referring to FIG. 1, a delay library generation device of embodiment 1 includes a simulator 101 for simulating a circuit operation, such as a SPICE (Simulation Program with Integrated Circuit Emphasis), or the like, and a characterize tool 102 for extracting a characteristic value based on a simulation result. Specifically, the characterize tool 102 includes a simulator control section 103, a delay characteristic extraction/simulation result determination section 104, and a timing constraint value search control section 105.

The simulator control section 103 inputs data necessary for simulation to the simulator 101 to instruct execution of simulation. For example, the data necessary for simulation includes:
(1) a netlist including circuit connection information of a transistor, parasitic resistance and parasitic capacitance of each cell, which is to be included in a delay library subjected to simulation;
(2) a model parameter for the simulator 101;
(3) simulation execution conditions including the supply voltage and temperature, the time step of simulation, the gradient of an edge of an input signal waveform which is used for calculating a delay in consideration of deformation of the input signal waveform, the capacitance value which is used for calculating a delay in consideration of a variation in the output load capacitance, etc.; and
(4) a test vector which represents a transition of the level of a signal input to an input terminal and an expected value of the level of a signal output from an output terminal which is determined according to the level transition.

If the characteristic value to be obtained is a value which can be directly extracted from a simulation result without performing a binary search, e.g., the delay characteristic, the delay characteristic extraction/simulation result determination section 104 outputs the extracted value itself as a delay library. If the characteristic value is a value which requires a binary search, e.g., the timing constraint value, the delay characteristic extraction/simulation result determination section 104 determines whether or not the predicted value of the timing constraint value is larger than a true timing constraint value and outputs the determination result to the timing constraint value search control section 105.

The timing constraint value search control section 105 controls the process of searching for the timing constraint value based on a binary search method. Specifically, the timing constraint value search control section 105 controls the search process such that the search range of the timing constraint value is divided into two parts, and any one of the two parts is selected as a new search range based on the determination result obtained by the delay characteristic extraction/simulation result determination section 104. A value in the new search range (usually, a median value) is selected as a new predicted value, and the above setting process and simulation by the simulator 101 are repeated. The initial value of the search range of the timing constraint value is determined by static analysis as will be described later.

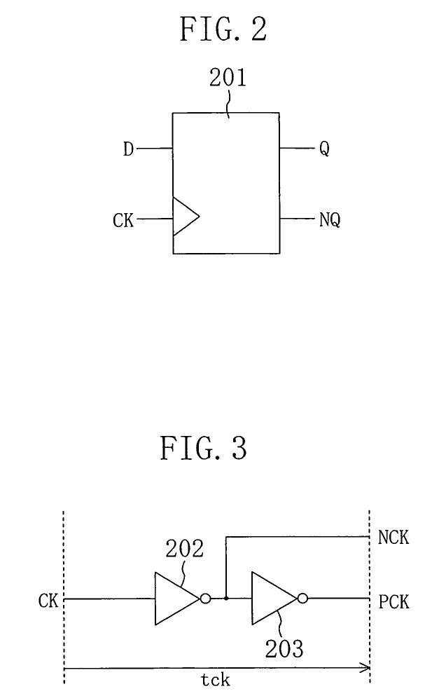

An example of the operation of the above-described delay library generation device is now described, wherein the set-up time and hold time of a D-flip flop circuit 201 shown in FIG. 2, which are the timing constraint values of the D-flip flop circuit 201, are obtained.

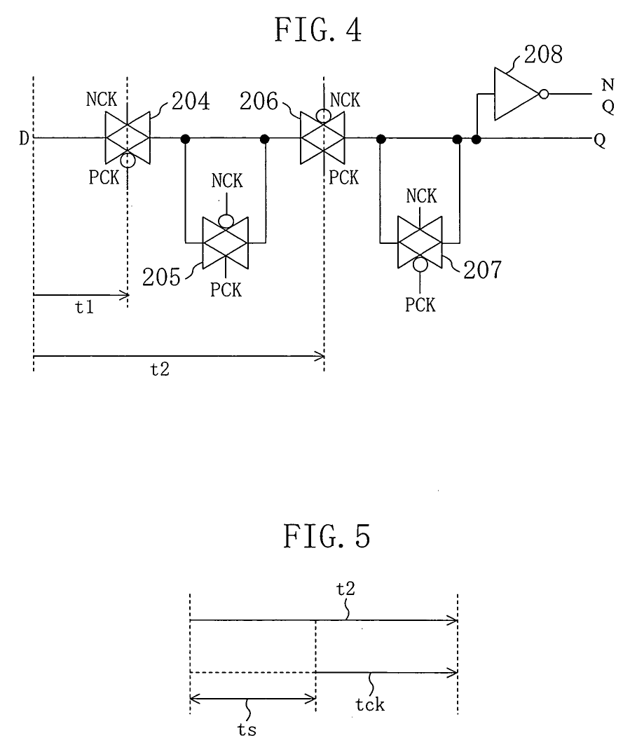

In the first place, the structure of the D-flip flop circuit 201, the set-up time and the hold time are briefly described. The D-flip flop circuit 201 has a structure shown in FIGS. 3 and 4, for example. FIG. 3 shows a circuit which generates clock signal PCK and inverted clock signal NCK based on clock signal CK input at a clock input terminal. This circuit includes two inverters 202 and 203. FIG. 4 shows a circuit structure between a data input terminal, to which data signal D is input, and output terminals for output signals Q and NQ. This circuit structure includes transfer gates 204 to 207 and an inverter 208. In FIG.3, “tck” schematically shows the delay time from the clock input terminal to the transfer gates 204 and 206. In FIG. 4, “t1” and “t2” schematically show the delay times from the data input terminal to the transfer gate 204 and the transfer gate 206, respectively.

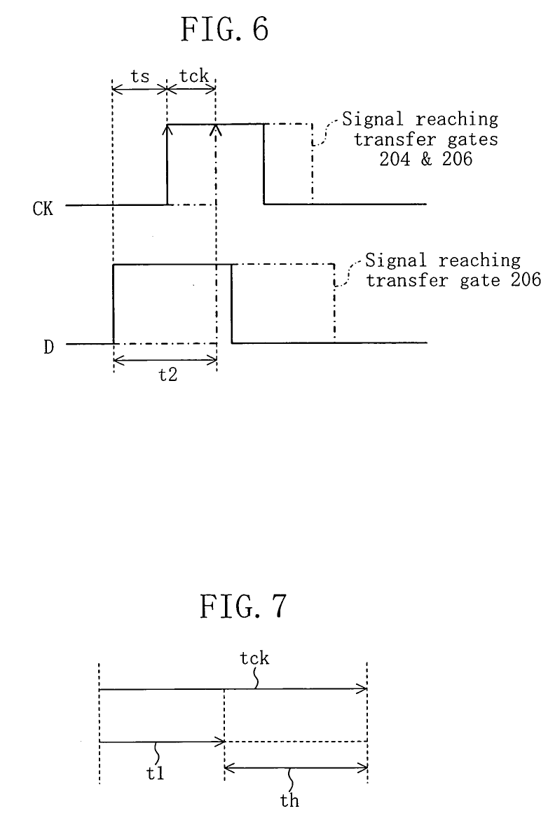

FIG. 5 schematically illustrates the relationship between delay times t2 and tck and set-up time ts. FIG. 5 shows that set-up time ts is equal to the difference between delay time t2 and delay time tck. FIG. 6 is a timing chart of an example where set-up time ts is just satisfied. In the case where the signal state of data signal D is taken in at a rising edge of clock signal CK, a correct signal value cannot be taken in unless the level of a signal which has been input through the data input terminal and reached the transfer gate 206 enters a stable state before a signal transition of clock signal CK from L (Low) level to H (High) level reaches the transfer gates 204 and 206. Thus, the time obtained by subtracting delay time tck (from the clock input terminal to the transfer gates 204 and 206) from delay time t2 (from the data input terminal to the transfer gate 206) is set-up time ts of the D-flip flop circuit 201.

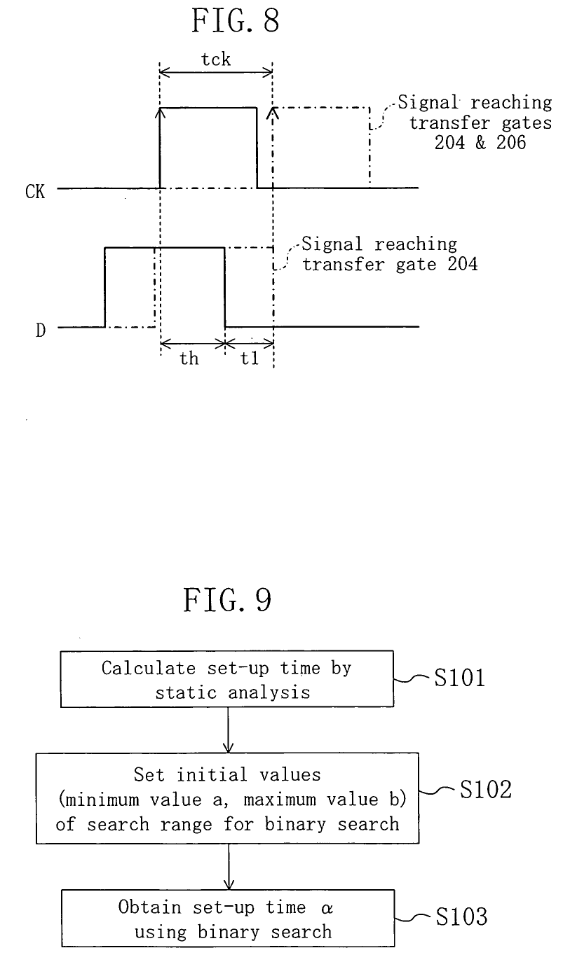

FIG. 7 schematically illustrates the relationship between delay times t1 and tck and hold time th. Hold time th is equal to the difference between delay time t1 and delay time tck. FIG. 8 is a timing chart of an example where hold time th is just satisfied. In the case where the signal state of data signal D is taken in at a rising edge of clock signal CK, a correct signal value cannot be taken in unless the level of a signal which has reached the transfer gate 204 enters a stable state before a signal transition of clock signal CK from L (Low) level to H (High) level reaches the transfer gates 204 and 206. Thus, the time obtained by subtracting delay time t1 (from the data input terminal to the transfer gate 204) from delay time tck (from the clock input terminal to the transfer gates 204 and 206) is hold time th of the D-flip flop circuit 201.

Set-up time ts and hold time th, which are obtained by subtraction with delay times t1, t2 and tck, are quickly obtained by static analysis. In the thus-obtained times (set-up time ts, etc.), the delay caused by a signal wire, crosstalk, or the like, is not considered, and therefore, the accuracy of these times is low as compared with the dynamic analysis in which such factors are considered. However, an error which may be caused by such factors is very small, and thus, the above delay times have an accuracy sufficient for decreasing the initial value of the search range (i.e., narrowing the initial search range) in the binary search process. Specifically, the delay times can readily be obtained with the range of 10 ns or smaller and, more preferably, with the range of about 0.5 ns.

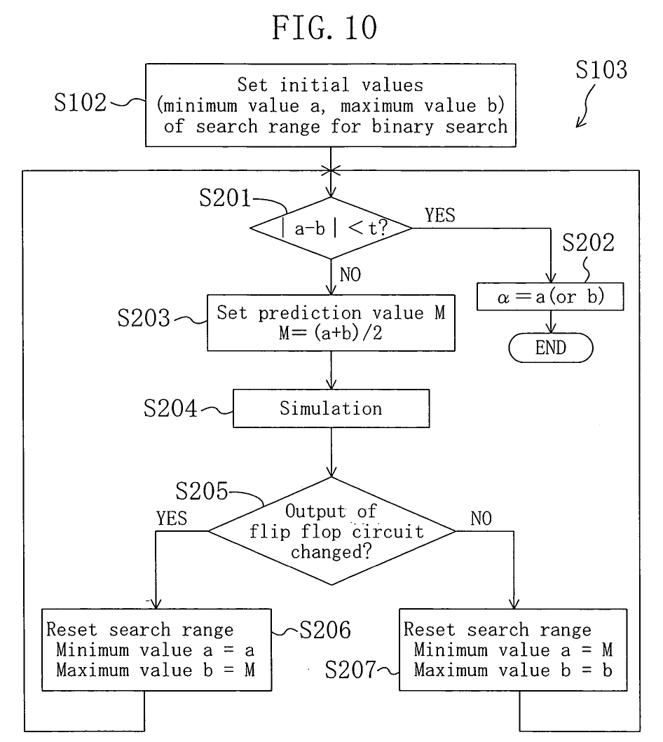

Hereinafter, an operation of the delay library generation device which is performed for calculating the above-described set-up time is specifically described with reference to FIGS. 9 and 10.

(S101) In the first place, the set-up time is calculated by a static analysis as described above.

(S102) Then, the initial value of the search range (minimum value a, maximum value b) is set such that the above set-up time is the median value. This search range can be set to a value determined in consideration of an error caused by a static analysis, e.g., 0.5 ns.

(S103) Correct set-up time α is obtained based on the initial value of the search range using binary search. Specifically, the process shown in FIG. 10 is performed.

(S201) It is determined whether or not the search range is equal to or smaller than desired minimum resolution t (|a−b|<t).

(S202) If the search range is equal to or smaller than minimum resolution t at S201, minimum value a or maximum value b of the search range is converged and set as set-up time α, and the process is ended.

(S203) If the search range is not equal to or smaller than minimum resolution t at S201, the median value of the search range, ((a+b)/2), is set as prediction value M.

(S204) The operation of the flip flop circuit which is performed when a data signal and a clock signal are input at a timing which just satisfies prediction value M is simulated. This simulation is high accuracy simulation in which a delay caused by a signal line, crosstalk, etc., are considered.

(S205) As a result of the above simulation, it is determined whether or not the data signal has been appropriately latched and the level of an output signal has changed. If the level of the output signal has not changed, true set-up time α is not satisfied, i.e., true set-up time α is longer than prediction value M (α>M). If the level of the output signal has changed, true set-up time α is satisfied, i.e., true set-up time α is equal to or shorter than prediction value M (α≦M).

(S206, S207) If the level of the output signal has changed at S205, the minimum value of the search range and prediction value M are respectively set as the minimum value and maximum value of the search range of the next simulation cycle. If the level of the output signal has not changed at S205, prediction value M and maximum value b of the search range are respectively set as the minimum value and maximum value of the search range of the next simulation cycle. Thereafter, the above-described process from step S201 is repeated. With the above, the search range is halved every time a cycle of simulation is performed. In the end, set-up time α converges to be equal to or lower than desired minimum resolution t.

Although the example of obtaining the set-up time has been described above, the operation is entirely the same also in an example of obtaining another timing constraint value, such as a hold time, or the like.

As described above, binary search is performed using the timing constraint value calculated by static analysis as the initial value, whereby the time required for obtaining a correct timing constraint value is decreased to a short time.

Specifically, where the initial value of the search range is X (ns) and the minimum resolution is 0.01 ns, the number of required simulation cycles is the smallest number of n in the following expression:
X×(½)ⁿ≦0.01.
Thus, when X=0.5 ns, n=6. Assuming that the time required for the static analysis is equal to one simulation cycle, a correct timing constraint value can be obtained with the time of 7 simulation cycles in total. That is, the required time is reduced by 30% as compared with a case where above-described prediction by static analysis is not performed and the initial value of the search range is 10 ns as described above (the number of required simulation cycles is 10).

### Embodiment 2

When there are a plurality of cells of the same type or a plurality of cells including a common circuit element, the timing constraint values of these cells are substantially equal in some cases. In such cases, a correct timing constraint value of any of the cells is obtained through the same process as that described in embodiment 1, and then, the initial value of the search range for the other cells is set based on the obtained timing constraint value, whereby the number of simulation cycles is decreased, and the timing constraint value is obtained in a short time period.

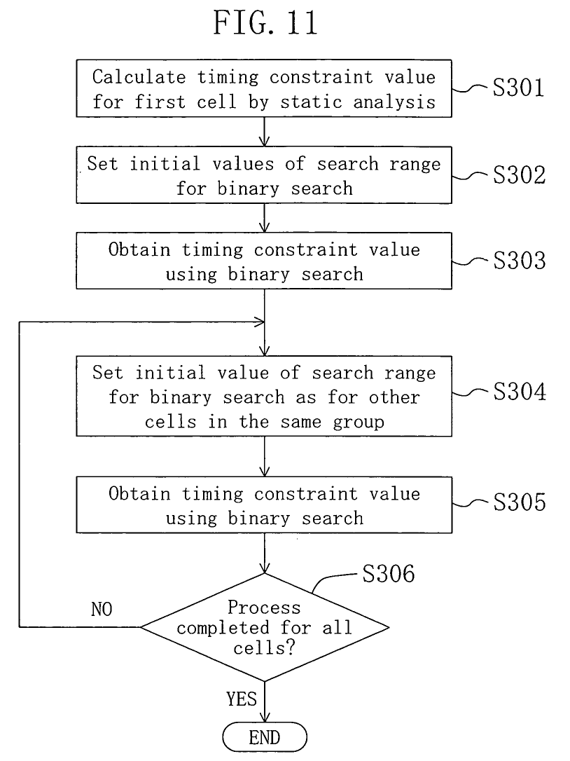

The delay library generation device which performs the above process basically has the same structure as that described in embodiment 1 (FIG. 1) except that the operation of the timing constraint value search control section 105 is different as shown in FIG. 11.

(S301 to S303) A correct timing constraint value of the first cell (representative cell) is obtained through the same process as that of steps S101 to S103 of embodiment 1 (FIG. 9).

(S304) As for another cell in the group including the first cell, the initial value of the search range is set such that the timing constraint value of the first cell is the median value of this search range. If the similarity of the cells is high, the search range can be set to a relatively narrow range, for example, 0.5 ns, because the timing constraint value of the first cell is a correct value.

(S305) A correct timing constraint value is obtained based on the initial value of the search range using binary search as in step S303.

(S306) It is determined whether or not the timing constraint values have been obtained for all of the cells in the same group. If not, the processes of steps S304 and S305 are repeated till the timing constraint values of all of the cells are obtained.

As described above, a correct timing constraint value obtained for a cell is used to obtain the timing constraint value of another cell, whereby the initial value of the search range can readily be set such that the search range becomes narrower. Thus, the time required for obtaining the timing constraint values of all of the cells is decreased to a short time period.

Specifically, assuming that the number of simulation cycles for the first cell is the same as the number determined in embodiment 1, i.e., 7 (including one cycle of static analysis) and, as for the other cells, the initial value of the search range is 0.5 ns and the minimum resolution is 0.01 ns, the number of simulation cycles necessary for each cell is 6. Where the number of all the cells is N, the number of total simulation cycles is:
7+(N−1)×6=6×N+1.
For example, when N=10, the number of total simulation cycles is 61.

If the timing constraint value of the representative cell is not used for the other cells and the initial value of the search range is 10 ns, 10 simulation cycles are performed on each cell. That is, 100 simulation cycles (10×10 =100) are performed in total. As compared with this case, the required time is reduced by 39% in the above example of embodiment 2.

It should be noted that it is not necessary to employ static analysis for setting the initial value of the search range for the first cell as in embodiment 1. In such a case, assuming that 10 simulation cycles are performed on the first cell (where the initial value of the search range is 10 ns), the number of total simulation cycles is:
10+(N−1)×6=6×N+4.
Thus, when N=10, the number of total simulation cycles is 64. As compared with this case, the required time is reduced by 36% in the above example of embodiment 2.

### Embodiment 3

The data given in the simulation of the circuit operation (logic circuit information, such as a netlist, and the like) are generated based on a circuit model. As the circuit model becomes more detailed, the accuracy of a result obtained from the circuit model becomes higher whereas the time required for the simulation becomes longer. In view of such, in embodiment 3, the timing constraint value is obtained by simulation and binary search based on logic circuit information of a simplified circuit model, and then, the initial value of the search range is reset based on the obtained timing constraint value to perform simulation and binary search based on logic circuit information of a detailed circuit model, whereby a timing constraint value of a desired accuracy is quickly obtained.

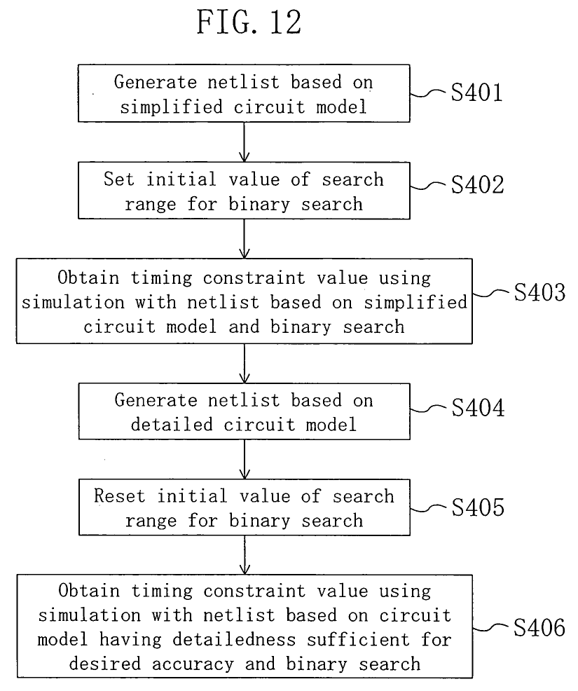

A delay library generation device which performs the above processes has a structure basically equivalent to that of embodiment 1 (FIG. 1) except that the timing constraint value search control section 105 performs the operation described below in conjunction with FIG. 12.

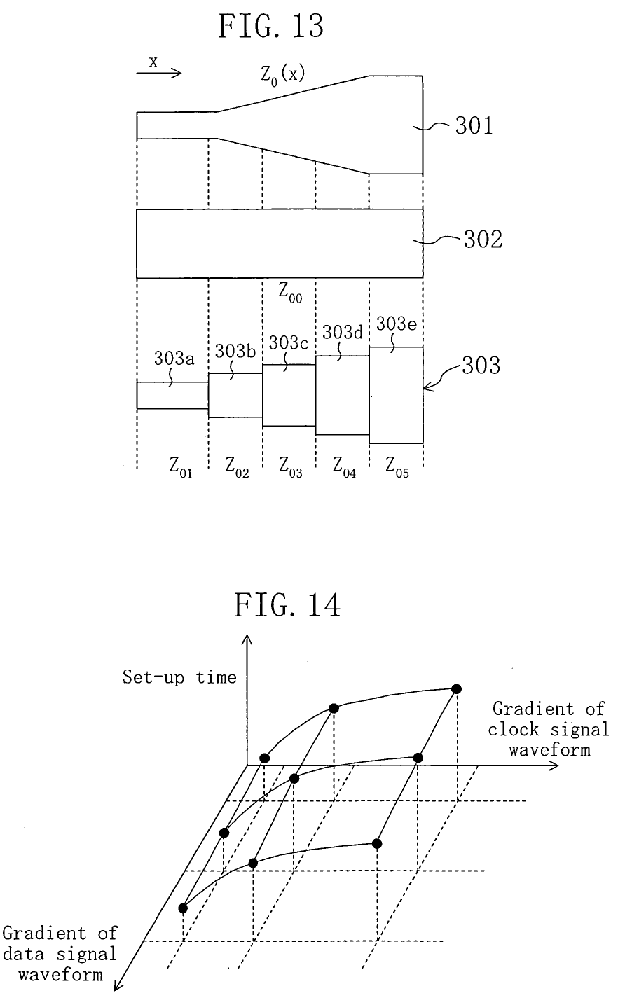

(S401) In the first place, a netlist is generated based on a simplified circuit model. Specifically, as shown in FIG. 13, for example, in the case where a signal wire (nonuniform transmission line) 301 whose width gradually changes and whose impedance is expressed by a function of the longitudinal position is used in a cell, the cell is modeled with an assumption that the signal wire 301 is a signal wire 302 which has a constant width and constant impedance Z₀₀ over the overall length or a predetermined longitudinal extent to generate a netlist. The accuracy of simulation based on the above-described simplified circuit model is not so high but is acceptable so long as a timing constraint value of an accuracy such that the number of simulation cycles is sufficiently reduced during the search for a correct timing constraint value at step S406 (described later), i.e., a timing constraint value of such an accuracy that the initial value of the search range is set small (i.e., the initial search range is set narrow), for example, 0.5 ns, can be obtained. Generation of a netlist at step S401 and step S404 (described later) may be performed in advance such that the netlist is simply read in at these steps.

(S402) The initial value of the search range is set for obtaining the timing constraint value for the above-described simplified circuit model. This search range need to be empirically set to be sufficiently large (e.g., about 10 ns) such that the timing constraint value is surely included in the search range.

(S403) The timing constraint value is obtained using binary search based on the above initial value of the search range as in step S103 of embodiment 1 (FIG. 9). It should be noted that at step S402 the simulation is performed more quickly because the simplified circuit model is used as described above.

(S404) A netlist is generated based on a circuit model which is more detailed than the signal wire 302. Specifically, for example, a cell is modeled with an assumption that the signal wire 301 which is a nonuniform transmission line is a signal wire 303 of FIG. 13 which is generated by wire parts 303a to 303e having constant impedances Z₀₁ to Z₀₅, respectively, are cascaded. This model is used to generate a netlist. The degree of dividing into the wire parts 303a to 303e may be set according to the accuracy required by the timing constraint value obtained at step S406 (described below).

(S405) The initial value of the search range is set again such that the timing constraint value obtained at step S403 is the median value. This search range may be set to a range determined according to the accuracy of the timing constraint value, for example, 0.5 ns.

(S406) The timing constraint value is obtained using binary search based on the above initial value of the search range as in step S403. In this case, the simulation is performed based on a detailed circuit model as described above. Thus, the timing constraint value is obtained with high accuracy. Although the time required for one simulation cycle is longer than that required at step S403 due to the high detailedness of the circuit model, the number of simulation cycles is reduced because the initial value of the search range is set small (i.e., the initial search range is set narrow) as described above. As a result, the total process time becomes short.

The timing constraint value is obtained through the two steps using circuit models of different detailedness as described above, whereby the processing time is reduced as described below.

For example, where the time required for 10 simulation cycles based on a detailed circuit model (10 is the number of simulation cycles required when the initial value of the search range is 10 ns and the minimum resolution is 0.01 ns) is T(s), the time required for simulation based on a simplified circuit model is α×T(s) (α<1), the accuracy of the timing constraint value of the first step is such that the initial value of the search range which is set for obtaining the timing constraint value of the second step is 0.5 ns, and the minimum resolution set for obtaining the timing constraint value of the second step is 0.01 ns, the time required for obtaining the timing constraint value of the second step is 0.6×T(s) because the number of simulation cycles is 6 as in embodiment 1. Thus, the total required time is α×T+0.6×T(s).

In the case where α=0.2, for example, the total required time is 0.8×T, which is shorter by 20% than the case where the initial value of the search range is 10 ns with a detailed circuit model.

It should be noted that an example of the simplified circuit model is not limited to the above. According to the present invention, an example where the capacitance between wires is approximated by the capacitance between a wire and the ground, an example where all the resistance components and capacitance components or the resistance components and capacitance components which are lower than predetermined values are neglected, etc., may be employed.

### Embodiment 4

An example of a delay library generation device is now described wherein the required time is readily reduced in the process of obtaining the timing constraint values corresponding to various operation conditions. For example, the set-up time of a flip flop circuit changes according to the gradients of edges of the waveforms of a data signal and a clock signal (the variation rate of the voltage) as schematically shown in FIG. 14. Thus, it is necessary to calculate the set-up times corresponding to the gradients of the edges of various signal waveforms and store the calculated set-up times in the delay library. This means that the total time required for generating the delay library is greatly reduced by reducing the time required for obtaining the respective set-up times.

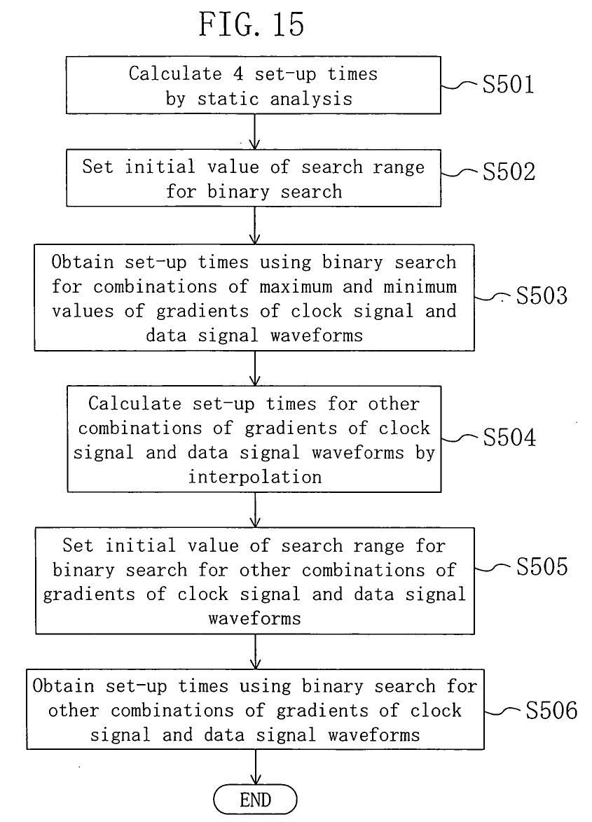

A delay library generation device of embodiment 4 has a structure basically equivalent to that of embodiment 1 (FIG. 1) except that the timing constraint value search control section 105 performs the operation described below in conjunction with FIG. 15.

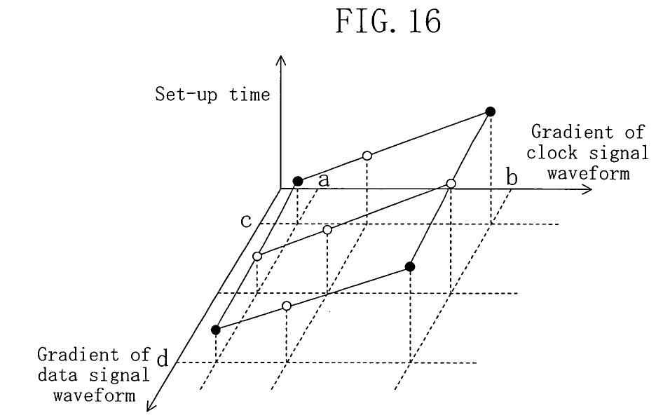

(S501 to S503) In the first place, as shown in FIG. 16, the set-up times are obtained as in embodiment 1 under 4 execution conditions which are determined based on the combinations of minimum value a and maximum value b of the gradient of the edge of the clock signal waveform and minimum value c and maximum value d of the gradient of the edge of the data signal waveform.

(S504) The set-up times are obtained by linear interpolation for other combinations of the value of the gradient of the edge of the clock signal waveform and the value of the gradient of the edge of the data signal waveform. The thus-obtained set-up times include errors but are generally approximate to the true set-up times.

(S505) The initial value of the search range is set such that the set-up time obtained by linear interpolation is the median value. This search range may be set to a relatively narrow range, for example, 0.5 ns, because the above set-up time is close to the true set-up time.

(S506) The timing constraint value is obtained using binary search based on the above initial value of the search range as in step S503.

A value obtained by interpolation from the set-up time accurately calculated for the gradients of the edges of some clock signal waveforms and data input signal waveforms is used, whereby the initial value of the search range is readily set small (i.e., the initial search range is readily set narrow). Thus, the time required for obtaining the timing constraint values for the gradients of the edges of various clock signal waveforms and data input signal waveforms is greatly reduced.

Specifically, assuming that the number of simulation cycles for the 4 set-up times obtained through steps S501 to S503 is the same as the number determined in embodiment 1, i.e., 4×7 (including one cycle of static analysis) and, as for the set-up time obtained through steps S505 and S506, the initial value of the search range is 0.5 ns and the minimum resolution is 0.01 ns, the number of simulation cycles necessary for each cell is 6. Where the number of all the set-up times to be obtained is N, the number of total simulation cycles is:
4×7+(N−4)×6=6×N+4.
For example, when N=20, the number of total simulation cycles is 124.

If above-described prediction by interpolation is not performed and the initial value of the search range is 10 ns for all of the set-up times, 10 simulation cycles are performed on each set-up time. That is, 200 simulation cycles (20×10=200) are performed in total. As compared with this case, the required time is reduced by 38% in the example of embodiment 4.

It should be noted that it is not necessary to employ static analysis for setting the initial value of the search range for the first 4 set-up times as in embodiment 1. In such a case, assuming that 10 simulation cycles are performed on each of the first 4 set-up times (where the initial value of the search range is 10 ns), the number of total simulation cycles is:
4×10+(N−4)×6=6×N+16.
Thus, when N=20, the number of total simulation cycles is 136. As compared with this case, the required time is reduced by 32% in the example of embodiment 4.

In the above example, the timing constraint value to be obtained is determined according to the two parameters, i.e., the gradient of an edge of the clock signal waveform and the gradient of an edge of the data signal waveform, but the present invention is not limited thereto. According to the present invention, for example, a timing constraint value which is determined according to one parameter or according to three or more parameters can be obtained in a short time period as well. Further, the interpolation is not limited to linear interpolation but may be interpolation with a quadratic curve. Alternatively, extrapolation may be employed instead of interpolation.

### Embodiment 5

In an example of embodiment 5 described below, the simulation accuracy is different among signal transmission routes (arcs) between input terminals and output terminals, such that the time required for simulation is reduced, and accordingly, the time required for acquiring the delay time, the timing constraint value, or the like, is reduced.

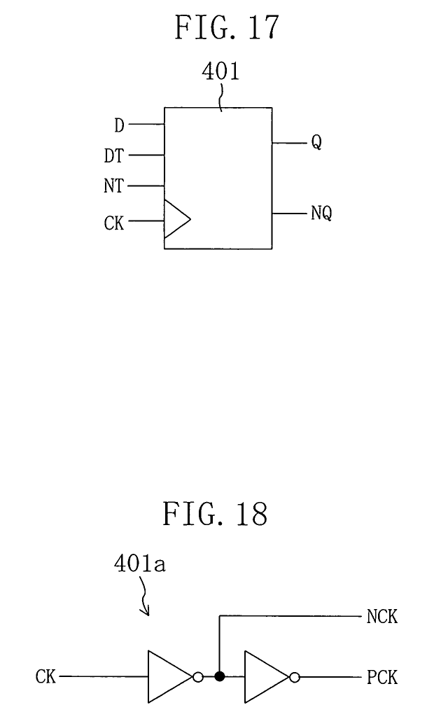

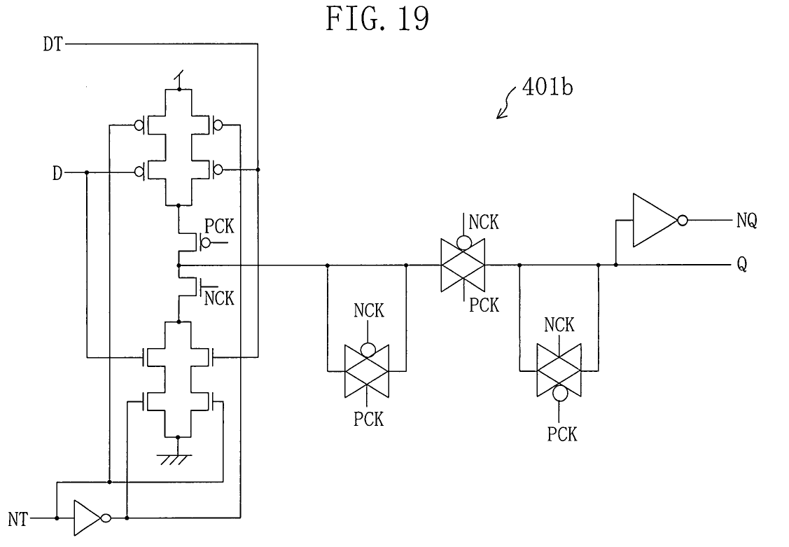

A flip flop circuit 401 for scan test, which is used in a scan chain for inspecting a semiconductor integrated circuit, is designed such that signals are input and output as shown in FIG. 17, for example. Specifically, the flip flop circuit 401 includes an internal clock generation circuit 401a shown in FIG. 18 and a data holding circuit 401b shown in FIG. 19. That is, the flip flop circuit 401 is designed such that scan test enable signal NT and scan test data input signal DT are input in addition to the input signals of a commonly-employed D-flip flop circuit. When scan test enable signal NT is at the L level, data signal D becomes valid so that the flip flop circuit 401 performs the same operation as that of a commonly-employed D-flip flop circuit. When scan test enable signal NT is at the H level, scan test data input signal DT becomes valid so that the flip flop circuit 401 holds scan test data input signal DT.

In the flip flop circuit 401 having the above structure, as for an arc associated with data signal D (arc associated with the normal operation mode), the delay margin is generally set to be small for the purpose of improving the operation speed and decreasing the chip area. Therefore, it is necessary to perform an accurate simulation to verify the operation timing. Thus, in the delay library, the delay time between the input terminal of data signal D and the output terminals of output signals Q and NQ, the timing constraint values, such as the set-up time of data signal D and clock signal CK, and the like, must be obtained with high accuracy. On the other hand, as for an arc associated with test mode, no problem occurs in some cases even when the accuracy of the delay time between the input terminal of scan test data input signal DT and the output terminals of output signals Q and NQ, the timing constraint values, such as the set-up time of scan test data input signal DT and clock signal CK, and the like, is relatively low. This is because the delay characteristic of the arc associated with test mode is used only for the timing verification of the test mode but not used for the timing verification of the normal operation mode, and meanwhile, the operation frequency is set to a low frequency in the test mode in general. Thus, there is a sufficient margin in the timing in many cases, and a sufficient delay margin can readily be provided. As a result, an error caused by low simulation accuracy is compensated.

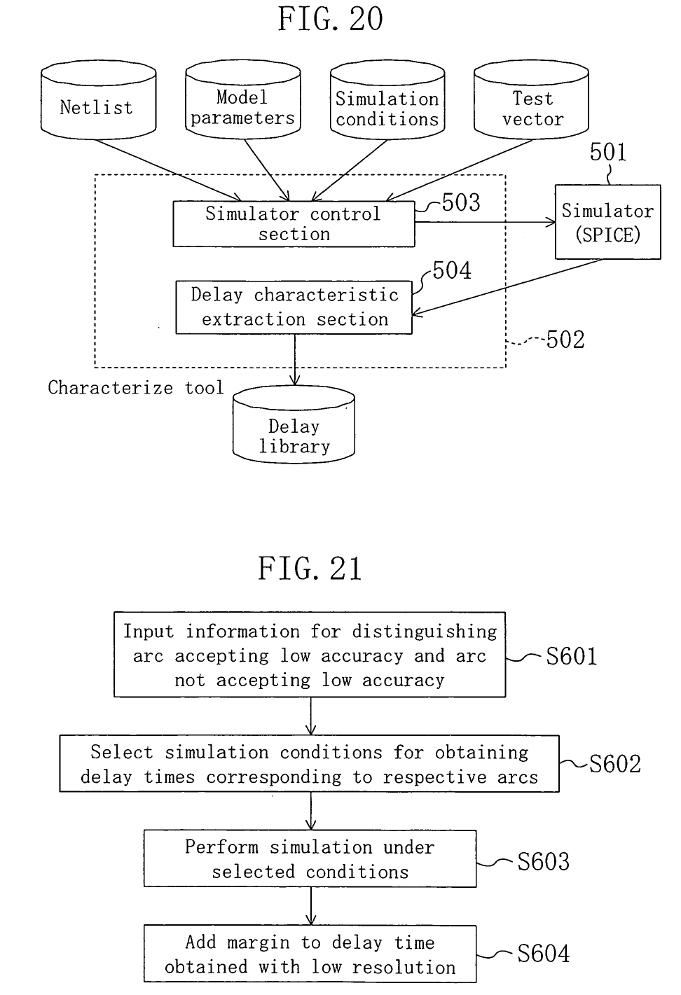

Referring to FIG. 20, a delay library generation device of embodiment 5 includes a simulator 501 for simulating the circuit operation and a characterize tool 502 for extracting a characteristic value based on a simulation result. More specifically, the characterize tool 502 includes a simulator control section 503 and a delay characteristic extraction section 504 for extracting a delay characteristic from a simulation result.

The simulator 501 and the simulator control section 503 have similar structures as those of the simulator 101 and the simulator control section 103 of embodiment 1 (FIG. 1) except that the accuracy of simulation can be changed according to the arc to be subjected to simulation.

Hereinafter, an operation of the delay library generation device of embodiment 5 for calculating the delay time is described with reference to FIG. 21.

(S601) In the first place, accuracy determination information is input for distinguishing an arc which requires simulation with high accuracy and an arc which accepts a relatively low accuracy according to whether the arc is associated with the normal operation mode or the test mode. It should be noted that the accuracy levels are not limited to two levels but may be three or more levels.

(S602) Then, the simulation conditions for calculating the delay times corresponding to respective arcs are set according to the accuracy determination information. Specifically, for example, the time steps (time intervals) of the simulation, etc., are set according to the accuracy determination information.

(S603) The simulation is performed according to the above settings to calculate the respective delay times. When the number of time steps of the simulation is small, a simulation result quickly converges, and accordingly, the time required for simulation is reduced.

(S604) Among the delay times obtained by the simulation, a delay margin is added to a delay time obtained by low accuracy simulation according to the accuracy of the simulation. For example, as for the arc associated with test mode, there is a sufficient margin in the timing in many cases as described above, and therefore, the delay margin can readily be added without causing any trouble in the circuit operation. Thus, the effect of an error caused by the low accuracy of the simulation can readily be avoided.

As described above, the simulation accuracy is partially decreased according to the arc, such that the time required for obtaining the timing constraint value and the delay time is readily decreased.

Specifically, where the simulation time for one cell which is required when the delay time is calculated with high accuracy is T(s), the proportion of arcs which can be simulated with relatively low accuracy to the entire arcs is α, and the simulation time required when the accuracy is decreased is β×T, the total time required for simulation is:
(α×β×T)+(1−α)×T(s)
In the case where α=0.5 and β=0.5 (the simulation time is halved for a ½ of the arcs), the reduction rate of the simulation time is:
1−{(0.5×0.5×T)+(1−0.5)×T}/T=0.25.
That is, the simulation time is reduced by 25%.

In the above-described example of embodiment 5, the delay library generation device obtains the delay time, but the present invention is not limited thereto. For example, even in the delay library generation devices of embodiments 1 to 4 wherein the timing constraint value is obtained using binary search, the required time is further reduced by setting the simulation conditions according to the required accuracy for each arc.

In the above-described example of embodiment 5, the accuracy of the simulation itself is changed according to the arc. Instead or in addition, in the case where the delay time is obtained according to the combination of the gradient of an edge of the input signal waveform and the output load capacitance or in the case where the timing constraint value is obtained according to the combination of the gradients of the edges of the input signal waveforms of the data signal and the clock signal in a flip flop circuit, the number of such combinations is changed according to the arc such that the number of simulation cycles is decreased.

The elements described in the above embodiments may be assembled into various combinations within the theoretically possible range. Specifically, the static analysis described in embodiment 1 (FIG. 9) is employed for obtaining a timing constraint value of a representative cell in embodiment 2 (FIG. 11) but may be replaced by a simulation based on a simplified circuit model described in embodiment 3 (FIG. 12). Further, a timing constraint value of a representative cell or a simplified circuit model which have been described in embodiments 2 and 3 may be employed in order to obtain the first 4 set-up times which are to be used for interpolation described in embodiment 4 (FIG. 15).

As described above, according to the present invention, a delay library of high accuracy can be generated efficiently within a short time period.

1. A method for generating a delay library including a timing constraint value which is used for verifying an operation timing of a logic circuit, comprising:
a timing constraint value acquisition step of acquiring a timing constraint value with an accuracy lower than a target accuracy; and
a timing constraint value search step of obtaining a converged timing constraint value using the timing constraint value and a predetermined search range as initial values by repeating an operation simulation under a predetermined operation condition and a reset of the search range and the timing constraint value by binary search based on a result of the operation simulation.

2. The delay library generation method of claim 1, wherein the timing constraint value acquisition step includes a timing constraint value calculation step of calculating the timing constraint value based on a delay value of an element included in the logic circuit.

3. The delay library generation method of claim 1, wherein:
the timing constraint value acquisition step includes a first timing constraint value search step of obtaining a converged timing constraint value for at least one of a plurality of logic circuits using the timing constraint value and a predetermined search range as initial values by repeating an operation simulation under a predetermined operation condition and a reset of the search range and the timing constraint value by binary search based on a result of the operation simulation; and
the timing constraint value search step includes a second timing constraint value search step of obtaining a converged timing constraint value for other logic circuits using the timing constraint value obtained at the first timing constraint value search step and the predetermined search range as initial values by repeating an operation simulation under a predetermined operation condition and a reset of the search range and the timing constraint value by binary search based on a result of the operation simulation.

4. The delay library generation method of claim 1, wherein:
the timing constraint value acquisition step includes a first timing constraint value search step of obtaining a converged timing constraint value for a simplified circuit model using the timing constraint value and a predetermined search range as initial values by repeating an operation simulation under a predetermined operation condition and a reset of the search range and the timing constraint value by binary search based on a result of the operation simulation; and
the timing constraint value search step includes a second timing constraint value search step of obtaining a converged timing constraint value for a circuit model which is more detailed than the simplified circuit model using the timing constraint value obtained at the first timing constraint value search step and the predetermined search range as initial values by repeating an operation simulation under a predetermined operation condition and a reset of the search range and the timing constraint value by binary search based on a result of the operation simulation.

5. The delay library generation method of claim 4, wherein the simplified circuit model is a circuit model in which a nonuniform transmission line is assumed as a uniform transmission line.

6. The delay library generation method of claim 1, wherein:
the timing constraint value acquisition step includes an interpolation/extrapolation step of calculating a third timing constraint value corresponding to a case where the predetermined operation condition is a third value by interpolation or extrapolation based on at least first and second timing constraint values corresponding to a case where at least a predetermined operation condition of the logic circuits includes at least first and second values; and
the timing constraint value search step includes the step of obtaining a converged third timing constraint value using the third timing constraint value and the predetermined search range as initial values by repeating an operation simulation under a condition that the predetermined operation condition is the third value and a reset of the search range and the timing constraint value by binary search based on a result of the operation simulation.

7. The delay library generation method of claim 6, further comprising an interpolation/extrapolation timing constraint value search step of obtaining a converged first or second timing constraint value using a predetermined timing constraint value and the predetermined search range as initial values by repeating an operation simulation and a reset of the search range and the timing constraint value by binary search based on a result of the operation simulation.

8. The delay library generation method of claim 6, wherein the predetermined operation condition is the variation rate of an input signal which is input to the logic circuit.

9. The delay library generation method of claim 1, wherein:
the timing constraint value search step includes
a simulation step of performing an operation simulation of the logic circuit under an operation condition which satisfies the initial timing constraint value or the reset timing constraint value, and
a search range/timing constraint value reset step of determining whether or not the timing constraint value is appropriate according to a result of the operation simulation to reset the search range and the timing constraint value by binary search; and
the simulation step and the search range/timing constraint value reset step are repeated till the search range converges to be within a predetermined range, whereby a timing constraint value is obtained.

10. The delay library generation method of claim 9, wherein the simulation step includes the step of setting a simulation condition such that the simulation is performed with different accuracies for signal transmission paths corresponding to timing constraint values.

11. A method for generating a delay library including a timing constraint value or delay value which is used for verifying an operation timing of a logic circuit, comprising:
a simulation condition setting step of setting a simulation condition such that the simulation is performed with different accuracies for signal transmission paths corresponding to timing constraint values or delay values;
a simulation step of performing a simulation of a circuit operation under the simulation condition; and
a characteristic value calculation step of calculating a timing constraint value or delay value based on a result of the simulation.

12. A device for generating a delay library including a timing constraint value which is used for verifying an operation timing of a logic circuit, comprising:
timing constraint value acquisition means for acquiring a timing constraint value with an accuracy lower than a target accuracy; and
timing constraint value search means for obtaining a converged timing constraint value using the timing constraint value and a predetermined search range as initial values by repeating an operation simulation under a predetermined operation condition and a reset of the search range and the timing constraint value by binary search based on a result of the operation simulation.

13. The delay library generation device of claim 12, wherein the timing constraint value acquisition means includes timing constraint value calculation means for calculating the timing constraint value based on a delay value of an element included in the logic circuit.

14. The delay library generation device of claim 12, wherein
the timing constraint value acquisition means includes first timing constraint value search means for obtaining a converged timing constraint value for at least one of a plurality of logic circuits using the timing constraint value and a predetermined search range as initial values by repeating an operation simulation under a predetermined operation condition and a reset of the search range and the timing constraint value by binary search based on a result of the operation simulation; and
the timing constraint value search means includes a second timing constraint value search means for obtaining a converged timing constraint value for other logic circuits using the timing constraint value obtained at the first timing constraint value search means and the predetermined search range as initial values by repeating an operation simulation under a predetermined operation condition and a reset of the search range and the timing constraint value by binary search based on a result of the operation simulation.

15. The delay library generation device of claim 12, wherein:
the timing constraint value acquisition means includes first timing constraint value search means for obtaining a converged timing constraint value for a simplified circuit model using the timing constraint value and a predetermined search range as initial values by repeating an operation simulation under a predetermined operation condition and a reset of the search range and the timing constraint value by binary search based on a result of the operation simulation; and
the timing constraint value search means includes second timing constraint value search means for obtaining a converged timing constraint value for a circuit model which is more detailed than the simplified circuit model using the timing constraint value obtained at the first timing constraint value search means and the predetermined search range as initial values by repeating an operation simulation under a predetermined operation condition and a reset of the search range and the timing constraint value by binary search based on a result of the operation simulation.

16. The delay library generation device of claim 15, wherein the simplified circuit model is a circuit model in which a nonuniform transmission line is assumed as a uniform transmission line.

17. The delay library generation device of claim 12, wherein:
the timing constraint value acquisition means includes interpolation/extrapolation means for calculating a third timing constraint value corresponding to a case where the predetermined operation condition is a third value by interpolation or extrapolation based on at least first and second timing constraint values corresponding to a case where at least a predetermined operation condition of the logic circuits includes at least first and second values; and
the timing constraint value search means obtains a converged third timing constraint value using the third timing constraint value and the predetermined search range as initial values by repeating an operation simulation under a condition that the predetermined operation condition is the third value and a reset of the search range and the timing constraint value by binary search based on a result of the operation simulation.

18. The delay library generation device of claim 17, further comprising interpolation/extrapolation timing constraint value search means for obtaining a converged first or second timing constraint value using a predetermined timing constraint value and the predetermined search range as initial values by repeating an operation simulation and a reset of the search range and the timing constraint value by binary search based on a result of the operation simulation.

19. The delay library generation device of claim 17, wherein the predetermined operation condition is the variation rate of an input signal which is input to the logic circuit.

20. The delay library generation device of claim 12, wherein:
the timing constraint value search means includes
simulation means for performing an operation simulation of the logic circuit under an operation condition which satisfies the initial timing constraint value or the reset timing constraint value, and
search range/timing constraint value reset means for determining whether or not the timing constraint value is appropriate according to a result of the operation simulation to reset the search range and the timing constraint value by binary search; and
the simulation means and the search range/timing constraint value reset means repeatedly operate till the search range converges to be within a predetermined range, whereby a timing constraint value is obtained.

21. The delay library generation device of claim 20, wherein the simulation means sets a simulation condition such that the simulation is performed with different accuracies for signal transmission paths corresponding to timing constraint values.

22. A device for generating a delay library including a timing constraint value or delay value which is used for verifying an operation timing of a logic circuit, comprising:
simulation condition setting means for setting a simulation condition such that the simulation is performed with different accuracies for signal transmission paths corresponding to timing constraint values or delay values;
simulation means for performing a simulation of a circuit operation under the simulation condition; and
characteristic value calculation means for calculating a timing constraint value or delay value based on a result of the simulation.
